(19) United States
(12) Patent Application Publication
(10) Pub. No.: US 2009/0022423 A1
(43) Pub. Date: Jan. 22, 2009

(54) METHOD FOR COMBINING SEVERAL IMAGES TO A FULL IMAGE IN THE BIRD'S EYE VIEW

(76) Inventors: Tobias Ehlgen, Tuebingen (DE); Joachim Gloger, Bibertal (DE)

Correspondence Address: PATENT CENTRAL LLC;Stephan A. Pendorf, 1401 Hollywood Boulevard, Hollywood, FL, 33020, US

(21) Appl. No.: 12/161,925

(22) PCT Filed: Jan. 12, 2007
(86) PCT No.: PCT/EP07/00231

§ 371 Date: Jul. 23, 2008

(30) Foreign Application Priority Data
Jan. 24, 2006 (DE) 10-2006-003-538.0

(51) Int. Cl. G06K 9/36

(52) U.S. Cl. 382/284

(57) ABSTRACT

During the combination of several adjacent images to a full image in the bird's eye view, points of discontinuity in addition to distortions can form in the overlapping regions of individual image portions, in which detected objects cannot be detected due to perspective differences. The aim of the invention is therefore to provide a method for combining several images to a full image in the bird's eye view, wherein at least two images of overlapping or adjacent surrounding regions are captured from different image recording positions (2, 3). The images are then transformed into the bird's eye view, the image portions of the transformed images being combined to form a full image in the bird's eye view. The image portions are combined in such a manner that shadings (5, 6) caused by moving objects are projected in the full image and during transition from a first image portion (7, 8) to a second image portion (8, 7) essentially in the same direction on a previously defined reference surface.

The invention relates to a method for combining several images to form a composite bird's eye view image.

From the prior art it is known to combine several images captured from different recording positions and/or recording directions to form a composite image. The reason for this is frequently that the largest possible surrounding area is to be reproduced with a single image representation. This is known, for example, from photography where a plurality of individual images are combined to form a panorama image. It is also known to combine several images from different image sensors (camera, radar, . . . ) by means of a computer unit to form a composite image. However, in this context there is usually a large amount of processing work since the respective image information items have to be adapted to one another before the combination. For example, images from several cameras which have different resolution or which are sensitive in different wavelength ranges (IR, VIS, . . . ) are combined to form a composite image. Furthermore, it is known to convert panoramic images or images taken from any other perspective into a bird's eye view image representation. For example, such representations from a bird's eye view are used when capturing the surroundings by means of cameras on vehicles, where, for example, a bird's eye view image of the surroundings is represented to a driver on a display during the parking process.

DE 102005023461A1 discloses a monitoring device with several image recording units and a unit for combining images. The images which have been recorded are converted, by adapting the viewing angle, into, in each case, an overview image with the same angle of inclination. A broadband overview image is generated by joining all the overview images by means of the unit for combining images, and identical sceneries of all the overview images are superimposed. In the broadband overview image, in each case that overview image with the highest image quality of the superimposed area is selected from all the overview images so that distortions are minimized. According to one version, the overview image with the highest image quality is that overview image in which a specific object is represented as the largest within the superimposed area. According to another version, the overview image with the highest image quality is that overview image in which the absolute value of the change in the angle of inclination of a specific object in the superimposed area before and after the conversion of the viewing angle is lowest.

DE 10296593 T5 discloses that, when several component images with different perspectives are superimposed to form a composite image, distortions occur. This is shown using the example of images of a parked vehicle which is captured by means of a rearview camera and a virtual camera arranged above the vehicle. In this context, only those viewing points which are located on the three-dimensional travel surface are suitable for the conversion to form a composite image, and the objects located above the travel surface are represented distorted in the composite image. With the device which is presented for assisting the driver, an image of the surroundings which is captured is therefore firstly converted into an image which is seen from a virtual viewing point above the image recording device, or an image which is projected from above orthogonally, on the basis of a model of the road surface. Three-dimensional information, which is different from that on the road surface, is then detected on the basis of a parallax between images. Distortion corrections are then carried out on the basis of the detected three-dimensional information.

The invention is based on the object of providing a method for combining several images to form a composite bird's eye view image which requires little processing work and permits reliable reproduction of image information.

The object is achieved according to the invention by means of a method having the features of patent claim 1. Advantageous refinements and developments are presented in the subclaims.

According to the invention, a method is proposed for combining several images to form a composite bird's eye view image. In this context, at least two images of overlapping or adjoining surrounding areas are captured from different image recording positions. The at least two images are then transformed into the bird's eye view and image portions of the transformed images are combined to form a composite bird's eye view image. The image portions are selected here in such a way that shadowing caused by moving objects at the junction between a first image portion and a second image portion in the composite image is projected essentially in the same direction onto a previously defined reference surface. As a result, the invention permits image information to be reliably reproduced with little processing work. At the same time, in a particularly beneficial way, even raised objects which move and change between the at least two image portions are visible at any time in the composite bird's eye view image. This would otherwise not necessarily be the case since in the junction area between the image portions in the composite image jumps can occur owing to scaling effects, with objects located in this junction area then being at least temporarily invisible. The explanation for this is that an object whose image is taken from two different recording positions and which is located between these two recording positions can be seen from different perspectives in the respective images. When the individual image portions are combined to form a composite bird's eye view image, these different perspectives result in differences in scaling at the junction area between the two image portions in the composite bird's eye view image, for which reason raised objects in the junction area are represented in a distorted way, or are even completely invisible. For this reason, a reference plane is defined when the transformation into the bird's eye view is performed, with those objects which are located within the reference plane being always visible and not being represented in a distorted way. In contrast, objects which are located above the reference plane are represented in a distorted way. The distortions increase here as the distance of an object from the reference plane increases. If the object has a vertical extension and projects out of the reference plane, the object is at least briefly invisible at the junction between a first image portion and a second image portion in the composite image. The time period in which an object is not visible at the junction increases here as the distance from the recording positions increases or as the difference between the perspectives at the junction area increases. The method according to the invention prevents objects being invisible at the junction between adjacent image portions by virtue of the fact that the image portions are selected in such a way that shadowing caused by moving objects at the junction in the composite image between a first image portion and a second image portion is projected essentially in the same direction onto the previously defined reference surface. As a result, although objects at the junction between image portions in the composite image are represented with different scaling, the objects are visible at any time. When the method according to the invention is used, a user is therefore informed with a high degree of reliability about the presence of objects, for which neither a complex 3D image data evaluation nor object tracking is required.

The image information which is acquired from different recording positions in transformed into the bird's eye view by virtue of the fact that it is firstly projected onto a previously defined reference surface. Images of the projected image information are then preferably captured by means of a pin hole camera model from the bird's eye view from a virtual position which is located above the reference surface. In a particularly advantageous method according to the invention, the reference surface here is that plane which approximates the ground surface above which the image recording positions are located, or a plane which is parallel to said plane. By varying the distance from the virtual camera position and the reference plane it is possible to adapt the scaling in the composite bird's eye view image.

Within the scope of the invention, individual images or individual image portions are usually transformed independently of one another into the bird's eye view. It is possible here for the images which are captured from different recording positions to be transformed completely into the bird's eye view, and in this context the transformed images can then be used to select suitable image portions for display or for further processing. As an alternative to this it is, however, also possible that in a further advantageous method according to the invention the at least two image portions are already selected before the transformation into the bird's eye view. As a result, the quantity of image data to be transformed is advantageously reduced, which significantly reduces the processing work.

It is also advantageous if the surface area ratio of the at least two images and/or image portions is different. Even if the at least two images have the same size owing to the image sensor or sensors used, it is appropriate if the size of the images or image portions is adapted in such a way that they have areas of different sizes. As a result, when the transformation into the bird's eye view is performed, the information is presented in a way which is intuitively more plausible to the user. In one preferred embodiment of the invention, the transformation is preferably carried out in such a way that in the composite image approximately ¾ of the image components of an image originate from a first image recording position, and approximately ¼ of the image components of another image originate from a second image recording position. As a result, the surface area ratio of the at least two image portions in the composite image is approximately 3:4. The junction between the two image portions is in this context preferably not along a boundary line which runs vertically in the center of the composite image but preferably along a boundary line which runs asymmetrically between the image portions in the composite image. In this context, the boundary line does not necessarily have to be a straight line, the boundary line here may also be, for example, a curve depending on the arrangement of the image sensor system and/or its design.

In one particularly preferred embodiment, reference tables, referred to as lookup tables, are used for the transformation of the images into a bird's eye view. For this purpose, a description of the relationships between an image and an image which has been transformed into the bird's eye view is stored in a data structure in the memory. Therefore, during the transformation complicated and costly running time problems are replaced by simple access to this data structure. This measure leads in a beneficial way to a considerable reduction in the processing work.

Preferably image sensors, for example CCD or CMOS sensors which can be sensitive both in the visible and in the invisible wavelength spectrum, are suitable for use in the method according to the invention. In the context of the invention, the images here are images of standardized image sensors. If the image sensors are permanently arranged during their use and if the at least two image recording positions and/or the sensor orientations do not change, a single standardization of the image sensor or sensors is advantageously completely sufficient. However, if the image recording positions and/or sensor orientations change, renewed standardization is necessary. A person skilled in the art of image processing is already aware of a number of methods for standardizing cameras for this purpose from the prior art.

It is particularly advantageous if the images are captured by means of omnidirectional cameras. Such cameras are already known from the prior art and comprise essentially a camera chip and a mirror. It is therefore possible to use a single image to capture surrounding areas of up to 360°. In the context of the invention, when several omnidirectional cameras are used, they are standardized to a reference plane in a common coordinate system.

The method according to the invention is used in a particularly beneficial way for capturing the surroundings on a motor vehicle. So that the driver does not overlook obstacles or other road users, a composite bird's eye view image of the surroundings of the vehicle is displayed on a display in the passenger compartment of the vehicle. In this context, the surroundings of the vehicle can be displayed to the driver by means of a suitable selection of image portions which is intuitive and more detailed. The surroundings of the vehicle are preferably represented here without gaps. In this context, all the blind spot regions around the vehicle are also captured, including those which the driver would otherwise not be able to see with the vehicle mirrors. In practice it has been found that even entire vehicles or persons can “disappear” in the blind spot regions of a vehicle. When the method according to the invention is used, the objects which are contained in the blind spot regions are also reliably displayed to the driver only by means of the gapless representation from a bird's eye view. Even if said objects are raised and move, jumps owing to the perspective do not occur here at the junctions between individual image portions in the composite image but rather only distortions occur, and therefore objects in these areas can be seen completely in the composite image at all times. Objects may be highlighted in color in an optical display in this context, and can, for example, be represented in a flashing way if a collision is imminent, so that the driver can reliably register the objects. However, as well as optical displays, for example acoustic warning signals are also suitable. With a suitable sound system, acoustic warning signals can also be output in a directional-dependent fashion. There is also a possibility of further processing the results relating to the presence of objects which are acquired with the method and of therefore generating, for example, control signals for automatic intervention in the vehicle movement dynamics, and of therefore avoiding collisions. In addition to use in passenger cars, the method is also suitable, for example, for use in trucks, buses or construction vehicles, in particular since the driver frequently does not have a good view of the surroundings of the vehicle in such a context owing to the vehicle's superstructure. By using the method, the driver can be advantageously assisted, for example, when parking, turning off at traffic intersections or when maneuvering. Positions in the vicinity of the vehicle mirrors are ideal above all for the arrangement of image sensors on a vehicle. For example, in each case only one omnidirectional camera is required on the front outer corners of a vehicle in order to capture both the blind spot region in front of the front part of the vehicle and the blind spot regions on both sides of the vehicle.

Further features and advantages of the invention emerge from the following description of preferred exemplary embodiments on the basis of the figures. In the drawings:

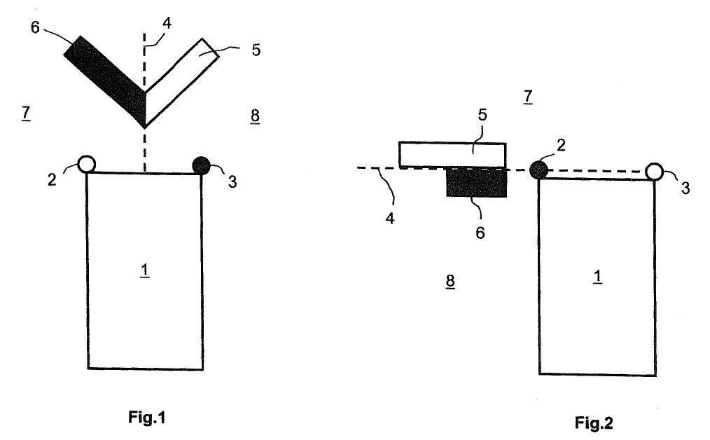

FIG. 1 shows the capture of images of the surroundings from two recording positions, with shadowing in different directions, and

FIG. 2 shows the capture of images of the surroundings from two recording positions, with shadowing in the same direction.

FIG. 1 shows by way of example the capture of images of the surroundings from two recording positions with shadowing in different directions. The vehicle here is a road vehicle (1) from the bird's eye view, which vehicle is equipped with an omnidirectional camera (2, 3) on each of the outer comers of the front part of the vehicle. Here, a boundary line (4) for defining image portions (7, 8) was selected in such a way that shadowing (5, 6) caused by objects is projected in different directions onto a reference plane. In the description of the exemplary embodiments, it is assumed in the following text that the reference plane is located in the plane of the drawing. Objects which are located to the left of the boundary line (4) in the image portion (7) are captured by means of the omnidirectional camera (2), and objects which are located to the right of the boundary line (4) in the image portion (8) are captured by means of the omnidirectional camera (3). When an object passes between the image portions (7, 8), both distortions and jumps may occur at the boundary line (4) depending on the height of the object. Objects which are located in the reference plane are projected in the image portions (7, 8) at the same positions in the image. In contrast, objects which are located outside the reference plane are projected in the image portions (7, 8) at different locations. Raised objects are therefore invisible in the region of the boundary line (4). Owing to the arrangement of the omnidirectional cameras (2, 3) which supply image portions (7, 8) of the same size in the composite image, objects in the region of the boundary line (4) are viewed from different perspectives and shadowing (5, 6) caused by these objects is projected in different directions in the reference plane. An object which is located in the region of the boundary line (4) and is captured by means of the omnidirectional camera (2) causes shadowing (5) in the reference plane, which shadowing is oriented to the right in the composite bird's eye view image. If, on the other hand, the same object is captured by means of the omnidirectional camera (3), shadowing (6) which is oriented to the left in the composite bird's eye view image is produced in the reference plane.

FIG. 2 shows by way of example the capture of images of the surroundings from two recording positions with shadowing in approximately the same direction. In contrast to the situation shown in FIG. 1, the boundary line (4) for the selection of image portions (7, 8) is selected here in such a way that shadowing (5, 6) caused by objects is projected essentially in the same direction onto the reference surface. In the composite bird's eye view image, the boundary line (4) runs, when viewed from the omnidirectional camera (3), through the position at which the omnidirectional camera (2) is installed. The surrounding area lying in front of the vehicle (1) is captured in this case with the omnidirectional camera (3) and is represented in the composite image as an image portion (7) which is located above the boundary line (4). The area to the left next to the vehicle (1) is captured with the omnidirectional camera (2) and is represented in the composite image as an image portion (8) which is located underneath the boundary line (4). By selecting a boundary line (4) which runs in such a way, the shadowing (5, 6) caused by an object in the region of the boundary line (4) in the composite image is scaled differently but the shadowing is visible in the composite image at all times irrespective of the height of the object. The profile of the boundary line (4) has been advantageously selected in such a way that the junction between the image portions (7, 8) is located on the driver's side in a left-hand vehicle. As a result, the relatively large blind spot regions on the right-hand side of the vehicle (1) are captured with the omnidirectional camera (3), and there is no junction between image portions on this side. However, it is equally also possible to place the junction on the right-hand side of the vehicle (1) by virtue of the boundary line (4). Furthermore it is not necessary for the boundary line (4) to run horizontally in the composite image. A diagonal profile of the boundary line (4) is also conceivable, in which case it is necessary to ensure that shadowing (5, 6) caused by moving objects at the junction between a first image portion (7, 8) and a second image portion (8, 7) in the composite image is projected essentially in the same direction onto a previously defined reference surface.

### LIST OF REFERENCE NUMERALS

1 Vehicle
2, 3 Omnidirectional cameras
Boundary line
5, 6 Shadowing
7, 8 Image portion

1. A method for combining several images to form a composite bird's eye view image, comprising:
capturing at least two images of overlapping or adjoining surrounding areas are from different image recording positions,
transforming the at least two images into the bird's eye view,
combining image portions (7, 8) of the transformed images to form a composite bird's eye view image, and
selecting the image portions (7, 8) in such a way that shadowing (5, 6) caused by moving objects at the junction in the composite image between a first image portion (7, 8) and a second image portion (8, 7) is projected in the same direction onto a previously defined reference surface.

2. The method as claimed in claim 1, wherein the reference surface is that plane which approximates the ground surface above which the image recording positions are located, or a plane which is parallel to said plane.

3. The method as claimed in claim 1, wherein the at least two image portions (7, 8) are already selected before the transformation into the bird's eye view.

4. The method as claimed in claim 1, wherein the surface area ratio of the at least two images and/or image portions (7, 8) is different

5. The method as claimed in claim 4, characterized in that wherein the surface area ratio is 3:4.

6. The method as claimed in claim 1, wherein a boundary line (4) runs asymmetrically between the image portions in the composite image.

7. The method as claimed in claim 1, wherein reference tables are used for the transformation of the images into a bird's eye view.

8. The method as claimed in claim 1, wherein the images are images of standardized image sensors.

9. The method as claimed in claim 1, wherein the images are captured by means of omnidirectional cameras (2, 3).

10. A method for capturing the surroundings on a motor vehicle (1) by combining several images to form a composite bird's eye view image, the method comprising
capturing at least two images of overlapping or adjoining surrounding areas from different image recording positions,
transforming the at least two images into the bird's eye view,
combining the image portions (7, 8) of the transformed images to form a composite bird's eye view image, and
selecting the image portions (7, 8) in such a way that shadowing (5, 6) caused by moving objects at the junction in the composite image between a first image portion (7, 8) and a second image portion (8, 7) is projected in the same direction onto a previously defined reference surface.
